(19) United States
(12) Patent Application Publication
(10) Pub. No.: US 2014/0118883 A1
(43) Pub. Date: May 1, 2014

(54) GRAPHENE SUPPORTED VANADIUM OXIDE MONOLAYER CAPACITOR MATERIAL AND METHOD OF MAKING THE SAME

(71) Applicant: Jian Xie, Carmel, IN (US)

(72) Inventor: Jian Xie, Carmel, IN (US)

(21) Appl. No.: 13/664,847

(22) Filed: Oct. 31, 2012

(51) Int. Cl. H01G 11/52

(52) U.S. Cl. CPC H01G 11/52
USPC 361/502

(57) ABSTRACT

An electronic device, including an electrically conductive graphene support structure and a vanadium oxide dielectric layer supported in electric communication with the electrically conductive graphene support structure.

### TECHNICAL FIELD

The novel technology relates generally to the field of electronic materials, and, more particularly, to a high capacitance material including alternating vanadium oxide monolayers or multilayers, each supported by a single graphene sheet substrate.

### BACKGROUND

Supercapacitors are useful for many applications because of their high power density, long cycle life and the potential applications on both military and commercial devices. For example, supercapacitors are important to the designs of portable laser systems and electric vehicles. Two mechanisms are associated with energy storage in a supercapacitor, namely electrical double layer charge storage and pseudo-capacitance charge storage. The capacitance of the former comes from the charge accumulation at the electrode/electrolyte interface, and therefore highly depends on the pore structure of the electrode, including such parameters as pore size and accessible surface area to the electrolyte molecules. The latter capacitance mechanism arises from to the fast reversible faradic transitions (electrosorption or surface redox reactions) of the electro-active species of the electrode, including surface functional groups, transition metal oxides and conducting polymers and this type of supercapacitor is also called electrochemical supercapacitors. The pseudo-capacitance from reversible faradic reactions of an electro-active material offers a higher power storage capacity than the electrical double layer capacitance mechanism.

Transition metal oxides have typically been considered to have a great potential to increase the capacitance in the electrochemical supercapacitors. Amorphous hydrated RuO₂ has attracted particular interest as a supercapacitor electrode material with a capacitance over 700 F/g having been achieved, significantly higher than that has been observed with an electrical double layer capacitor. Unfortunately, hydrated RuO₂ is too rare and expensive to be commercially viable as a supercapacitor material. Supercapicitors utilizing nano-crystalline vanadium nitride materials have exhibited capacitance of 1340 F/g at a 2 mV/s scan rate, which is far more than that of the hydrated RuO₂ based supercapacitors. Such a high capacitance is believed to be caused by a series of reversible redox reactions on few atomic layers of vanadium oxide on the surface of the underlying nitride nanocrystals, which exhibit a metallic electronic conductivity (σ_{bulk}=1.67X10⁶ Ω⁻¹ m⁻¹).

Thus, there remains a need to supercapacitor material having even higher capacitance and using more readily available materials. The present invention addresses this need.

### SUMMARY

The present novel technology relates to energy storage devices supporting vanadium oxide dielectric layers on graphene substrates.

One object of the present novel technology is to provide an improved capacitor device. Related objects and advantages of the present novel technology will be apparent from the following description.

### BRIEF DESCRIPTION OF THE DRAWINGS

FIG. 1 graphically illustrates a graphene/vanadium oxide composite dielectric material according to a first embodiment of the present novel technology, having vanadium oxide molecular monolayers connected to both sides of a graphene sheet.

FIG. 2 graphically illustrates the process of attaching vanadium oxide layers to functionalized graphene according to a second embodiment of the present novel technology.

FIG. 3 is a photomicrograph of graphene as synthesized through thermal expansion according to the embodiment of FIG. 2.

FIG. 4 schematically illustrates the functionalization of a carbon atom according to the embodiment of FIG. 2.

FIG. 5 chemically illustrates the process of FIG. 1.

FIG. 6 graphically illustrates a capacitor according to a third embodiment of the present novel technology.

### DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

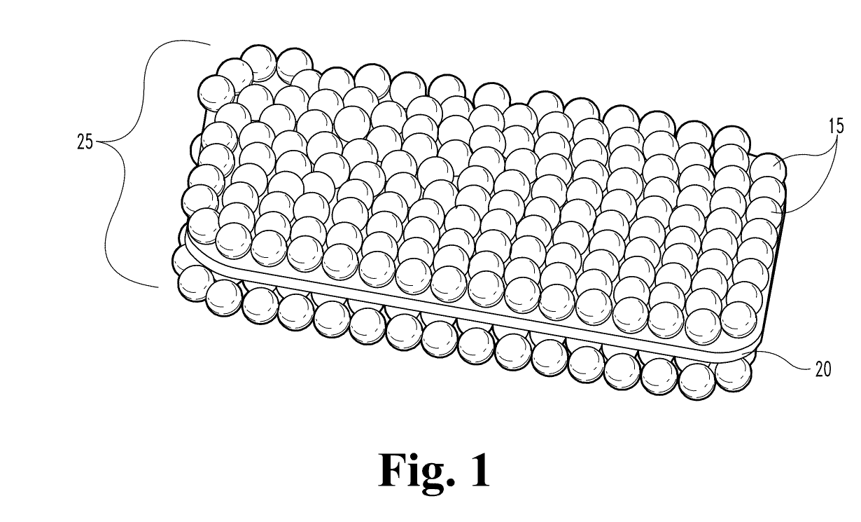

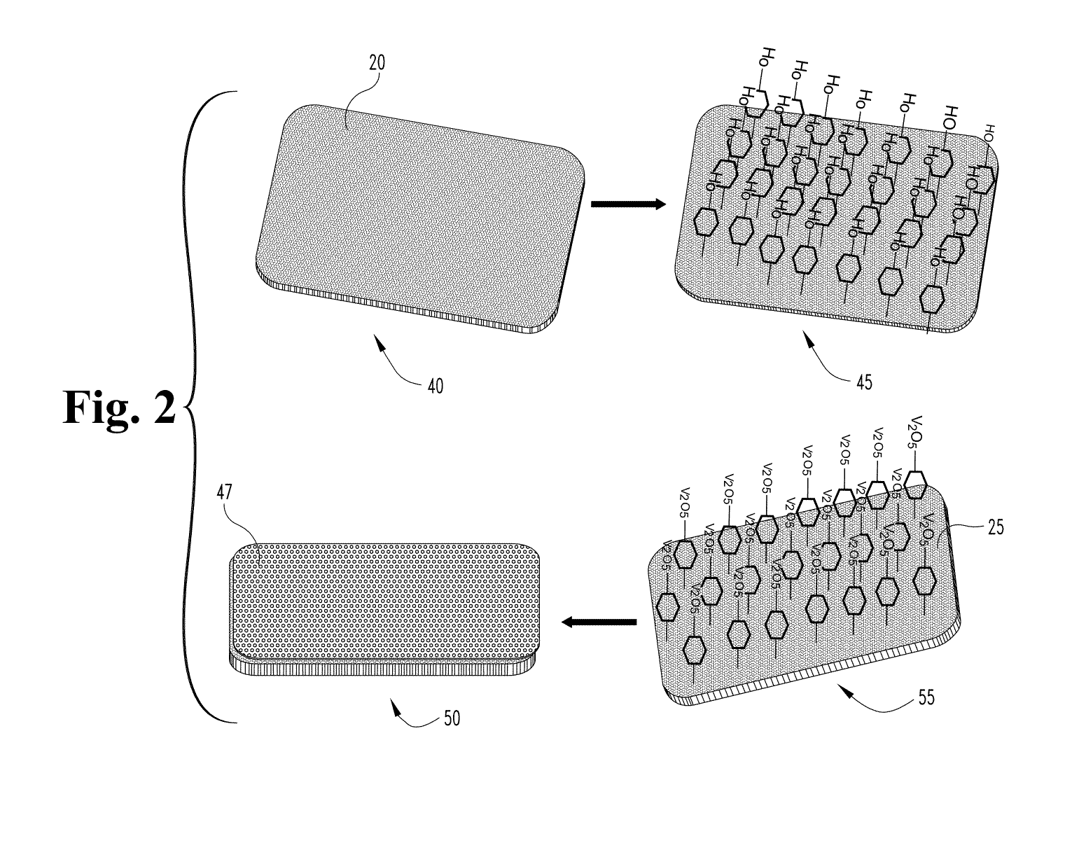

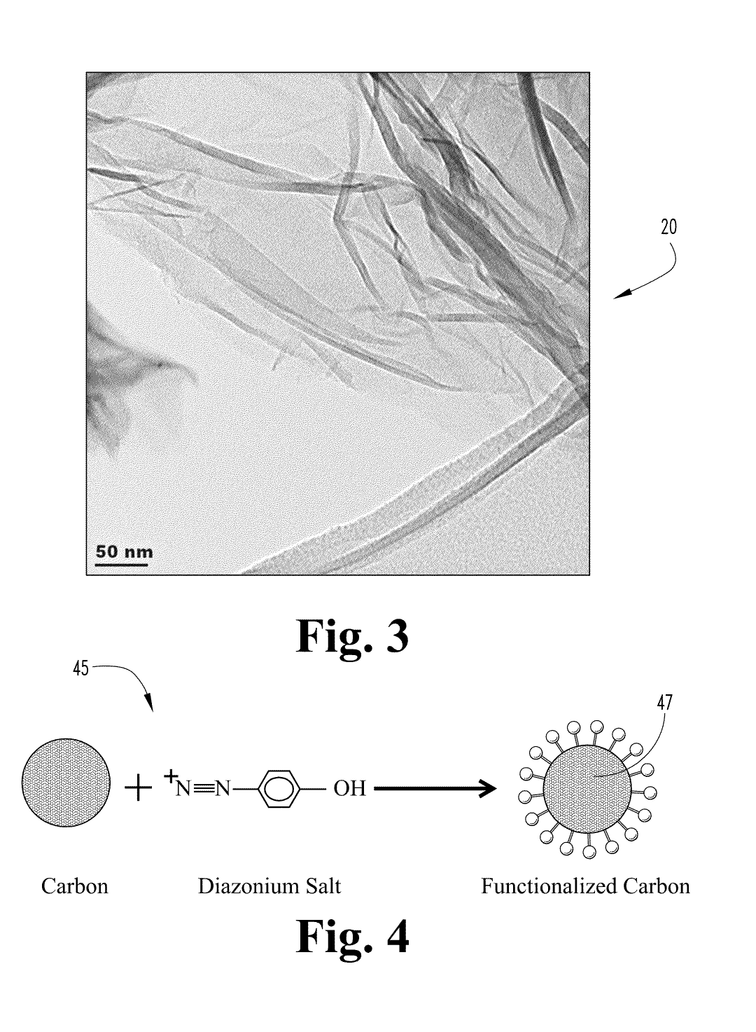

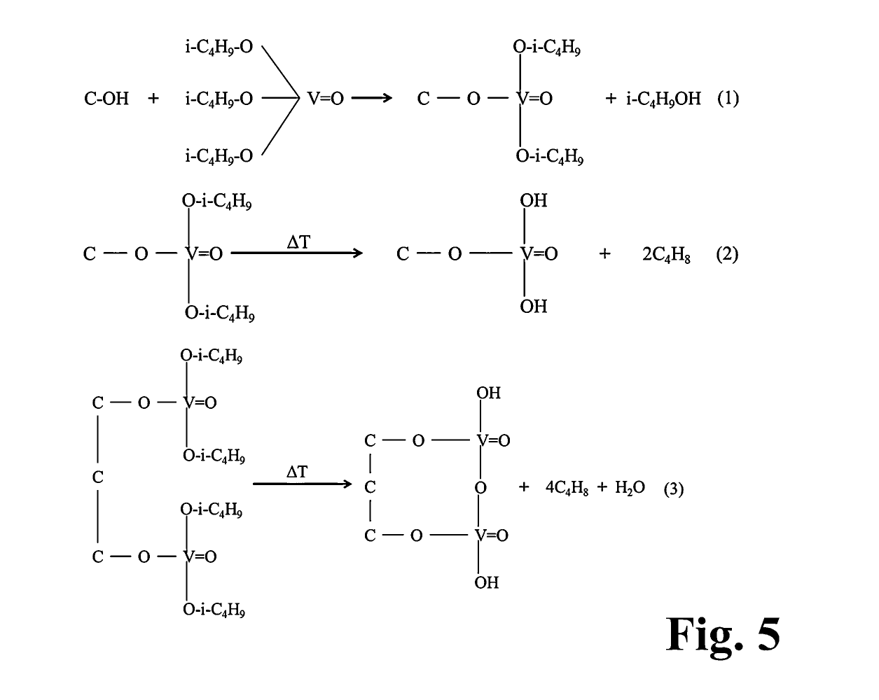

As illustrated in FIGS. 1-6, the present novel technology relates to capacitors, specifically capacitor devices 10 with nano-structured vanadium oxide molecules present as thin, ultrathin, or mono-layers 15 and supported on electrically conductive, typically carbonaceous, support structures 20. The carbonaceous support structure is typically one or more graphene sheets, although other morphologies of carbon, such as diamond, may be used. Such capacitors 10 may approach an extremely high theoretical capacitance of 4577 F/g and exhibit high electric conductivity and a low time constant. In contrast, the current state-of-art capacity of RuO₂ is only 700 F/g. The instant capacitors 10 represent a significant increase in supercapacitor energy storage for high power density applications, such as laser systems and electric vehicle (EV)/hybrid electric vehicle (HEV) systems.

The thin layer or, typically, monolayer of vanadium oxide molecules 15 supported on a graphene substrate 20 defines a V₂O₅/graphene composite 25. The structure of the composite 25 allows respective vanadium oxide (V₂O₅) molecules to avail themselves to electrolytes with high surface area accessibility for ions in the electrolytes, which in turn allows each V₂O₅ molecule to participate in the redox reaction and facilitates the fast mass transport of ions. The high capacitance of the composite material 25 appears to arise from the 3-electron redox reactions of vanadium oxide (V₂O₅) (V⁵⁺→V⁴⁺+1e⁻; V⁴⁺→V³⁺+1e⁻; and V³⁺→V²⁺+1e⁻). The V₂O₅ molecules in the monolayer 15 may directly electrically communicate with the carbon atoms in the graphene layer 20. Consequently, the electron transfers in the V₂O₅/graphene composite 25 primarily involve the direct transfer of electrons from the carbon atoms to the V₂O₅ molecules. Alternately, carbon spacers or the like may be positioned between the graphene substrate 20 and the vanadium oxide layer 15. The slow electron transfer between V₂O₅ molecules (which causes the extremely low electronic conductivity, 8.7×10⁻⁷ S cm⁻¹, and, consequently, limits the application of vanadium oxide in supercapacitors requiring low time constant) is thus minimized or eliminated. Accordingly, the electronic conductivity of V₂O₅/graphene composite 25 is greatly increased, resulting in a greatly reduced the time constant. In addition, the positioning of the V₂O₅ monolayer 15 on graphene 20 provides a very high mass ratio of active material to supporting material, 3.83 (V₂O₅:graphene=3.83), which is typically about fifteen times 15.32 of that of vanadium oxide/vanadium nitrides composites (V₂O₅/VN) (V₂O₅:VN=0.251). Vanadium oxide benefits from an electrically conducting support due to its low electronic conductivity, and the single carbon layer of graphene 20 is ideal, providing carbon support with minimized space constraints.

The nano-structured vanadium oxide monolayer 15 is formed and supported on graphene 20, and a thin film electrode 30 is typically fabricated thereupon to allow each V₂O₅/graphene composite sheet 25 to enjoy good electric communication or conduction. The synthesis of nano-structured vanadium oxide monolayer 15 supported on graphene 20 is typically achieved through the functionalization 40 of the graphene sheet 20 and the subsequent removal of benzene rings or the like from the functionalized graphene 20, following the attachment of vanadium ions/vanadium oxide monolayer 15 on the graphene substrate 20.

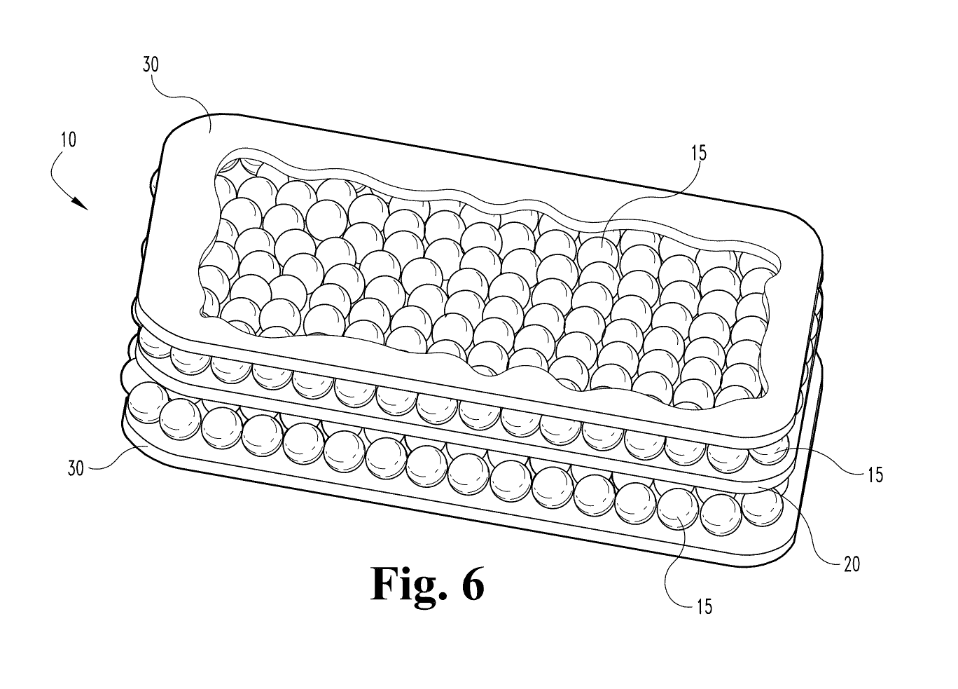

Graphene, a single-atom-thick sheet of hexagonally arrayed sp₂-bonded carbon atoms, is a two-dimensional macromolecule exhibiting extremely high surface area (2600 m²/g). The in-plane electronic conductivity (10⁹ Ω⁻¹ m⁻¹) of graphene is much higher than that of the vanadium nitride. Single sheet graphene 20 is a very good candidate for support of the vanadium oxide monolayer 15, as it has both good in-plane electrical conductivity as well as physical strength, as the in-plane carbon-carbon bonds are stronger than those in diamond. Graphene sheets may be synthesized, such as by the thermal expansion method or the like, and hydroxyl groups (—OH) may be chemically attached to the surface of graphene 20 through the diazonium reaction 45. The attachment of a vanadium oxide layer 15 onto the functionalized graphene 47 is typically carried out by a hydrothermal technqiue, such as has been used to vanadium oxide monolayer on alumina, silica, magnesia, and titania supports. Vanadium ions may be attached go to onto the functionalized graphene-OH 47 by impregnation of the same with vanadyl triisobutoxide and then typically purified such as by vacuum distillation (typically b.p. 414-415 K at 1.07 kPa). The use of an isobutyl alcohol derivative of vanadium offers the advantage of a monomeric nature, as compared to the methoxide. Alternately, the vanadium oxide layer 15 may be deposited by other convenient means, such as atomic layer deposition or the like. The functionalized graphene 47 is then typically impregnated with a solution of vanadyl triisobutoxide in anhydrous nhexane. After a predetermined period of time (typically about 24 hours) the solution is removed and the mixture is washed, typically several times, with solvent. The impregnated graphenes are subsequently calcined for a predetermined period of time (typically several hours, more typically about three hours) at elevated temperatures (typically, about 300° C.) in a stream of dry air to form the vanadium oxide monolayer 15 on graphene 20. In this calcination step, organic solvents such as benzene and the like are removed and the vanadium oxide monolayer 15 is directly formed 55 on the graphene substrate surface 20. The reaction scheme is shown in FIG. 6.

To make the high performance capacitor 10 characterized by extremely high capacitance, each vanadium oxide monolayer 15/graphene sheet 20 in the electrode layer 30 typically participates in the charging/discharging process. This participation arises because the electronic conduction between each vanadium oxide monolayer 15/graphene sheet 20 is maintained. Such conduction may benefit from the provision of an appropriately conductive electrode layer 30 structure. The structure of the desired electrode layer 30 typically has the graphene edges of vanadium oxide monolayer/graphene sheet composite 25 physically in contact with each other, or contacting through conductive metal substrates. For example, the synthesized vanadium oxide monolayer/graphene composites 25 are dispersed in organic solvents along with a binder to form a uniform dispersion. This dispersion is then coated onto a nickel substrate to form a thin layer 25 in metallic contact with the nickel substrate 30.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A capacitor, comprising:
a graphene sheet; and
a monolayer of V₂O₅ disposed on the graphene sheet.

2. The capacitor of claim 1 and further comprising:
a plurality of graphene sheets;
a plurality of V₂O₅ monolayers;
wherein each respective V₂O₅ monolayer is disposed between two respective graphene sheets.

3. The capacitor of claim 1 and further comprising a pair of oppositely disposed electrodes connected in electric communication to the capacitor.

4. The capacitor of claim 1 and further comprising a plurality of carbon spacers disposed between the graphene sheet and the V₂O₅ monolayer.

5. The capacitor of claim 1 wherein the graphene sheet is less than 10 atomic layers thick.

6. The capacitor of claim 1 wherein the graphene sheet is an atomic monolayer.

7. An electronic device, comprising:
an electrically conductive carbonaceous support structure; and
a vanadium oxide dielectric layer supported in electric communication with the electrically conductive carbonaceous support structure.

8. The device of claim 7 wherein the electrically conductive carbonaceous support structure is graphene and wherein the vanadium oxide dielectric layer is a V₂O₅ monolayer.

9. The device of claim 7 wherein the electrically conductive carbonaceous support structure is a graphene monolayer and wherein the vanadium oxide dielectric layer is a V₂O₅ monolayer.

10. The device of claim 7 wherein the electrically conductive carbonaceous support structure is a thin graphitic layer and wherein the vanadium oxide dielectric layer is V₂O₅.

11. The device of claim 7 wherein the electrically conductive carbonaceous support structure is a diamond layer and wherein the vanadium oxide dielectric layer is V₂O₅.

12. An energy storage device, comprising:
a plurality of electrically conductive graphene support layers; and
a plurality of dielectric V₂O₅ monolayers;
wherein substantially each respective V₂O₅ monolayer is disposed in electric communication between two graphene layers; and
wherein substantially each respective graphene layer is disposed between two V₂O₅ monolayers.

13. The energy storage device of claim 12 and further comprising;
a pair of oppositely disposed graphene end members connected in electric communication with respective V₂O₅ monolayers; and
a pair of electrode layers, each respective electrode layer operationally connected to a respective graphene end member.
